(19) United States
(12) Patent Application Publication
(10) Pub. No.: US 2008/0284554 A1
(43) Pub. Date: Nov. 20, 2008

(54) Compact robust linear position sensor

(76) Inventors: Thaddeus Schroeder, Rochester Hills, MI (US); Avoki Omekanda, Rochester Hills, MI (US)

Correspondence Address: DELPHI TECHNOLOGIES, INC., M/C 480-410-202, PO BOX 5052, TROY, MI, 48007, US

(21) Appl. No.: 11/803,236

(22) Filed: May 14, 2007

(51) Int. Cl. H01F 5/02; G01B 7/14

(52) U.S. Cl. 336/200; 324/207.24

(57) ABSTRACT

The present invention is directed to a position sensor, comprising a printed circuit board; a pair of stationary planar air-core coils formed in a trapezoidal or rectangular shape and side-by-side one another on the printed circuit board, coil windings being relatively uniformly distributed over a predetermined area of the printed circuit board; and a moving target formed by a sheet of copper on the printed circuit board.

### TECHNICAL FIELD

The present invention relates to a compact robust linear position sensor.

### BACKGROUND

A variety of automotive and industrial control system require absolute position sensors, either linear or angular, desirably, non-contacting and capable of operating down to a zero speed. In addition, a minimum level of durability is required, which virtually precludes optical types of sensors, and to a large degree, capacitive sensors.

The most frequently used type of sensor satisfying the above requirements is a magnetic sensor comprising an analog Hall or an anisotropic magnetoresistor (MR) device, and a position responsive magnetic circuit, which varies the magnetic flux as a function of position. The disadvantages are the bulk and cost of the magnetic circuit including the bias magnet, and the cost of either the Hall or the MR device, which must include a complex signal processing capability.

### SUMMARY OF THE INVENTION

The present invention relates to a position sensor comprising a printed circuit board; a pair of stationary planar air-core coils formed in a substantially trapezoidal or rectangular shape and side-by-side one another on the printed circuit board, coil windings being relatively uniformly distributed over a predetermined area of the printed circuit board; and a moving target formed by a sheet of copper on the printed circuit board.

Many variations in the embodiments of the present invention are contemplated as described during a more detailed. Other applications of the present invention will become apparent to those skilled in the art when the following description for practicing the invention is read in conjunction with the accompanying drawings.

### BRIEF DESCRIPTION OF THE DRAWINGS

The non-limiting description herein makes reference to the accompanying drawings wherein like reference numerals refer to like parts throughout the several views.

FIG. 1 shows reduced length linear ratiometric position sensor;

FIG. 2 shows relative output signal for different target lengths (modeling results);

FIG. 3 shows the interface circuit;

FIG. 4 shows robust sensor design;

FIG. 5 shows the interface circuit for robust design;

FIG. 6 shows a pair of rectangular coils; and

FIG. 7 shows a pair of trapezoidal coils.

### DETAILED DESCRIPTION OF THE INVENTION

Applicants teach a simple, robust and very inexpensive linear ratiometric position sensor. It is an inductive sensor comprising a pair of stationary planar air-core coils formed on a printed circuit board (PCB) and a moving target consisting of a thin sheet of copper also formed on a PCB. It provides several improvements over the known art.
decreased sensor length;
simplicity in designing desired output characteristics; and
insensitivity to air gap variations.

### Decreased Sensor Length

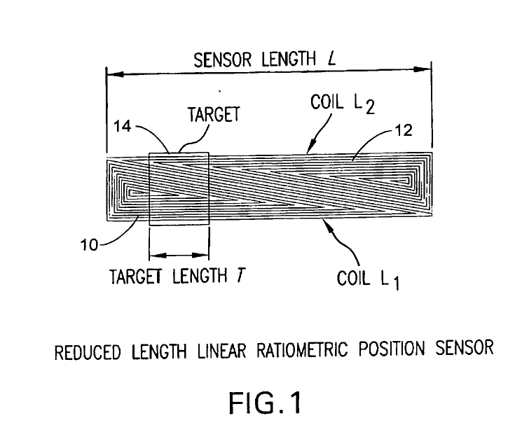

The present sensor offers design freedom to reduce its length without affecting its sensing range. It is accomplished by the use of a pair of planar triangular coils 10, 12 located side-by-side and a short target 14 as shown in FIG. 1.

The sensing range of the sensor is:

X=L−T where 0<T≦0.5L (1)

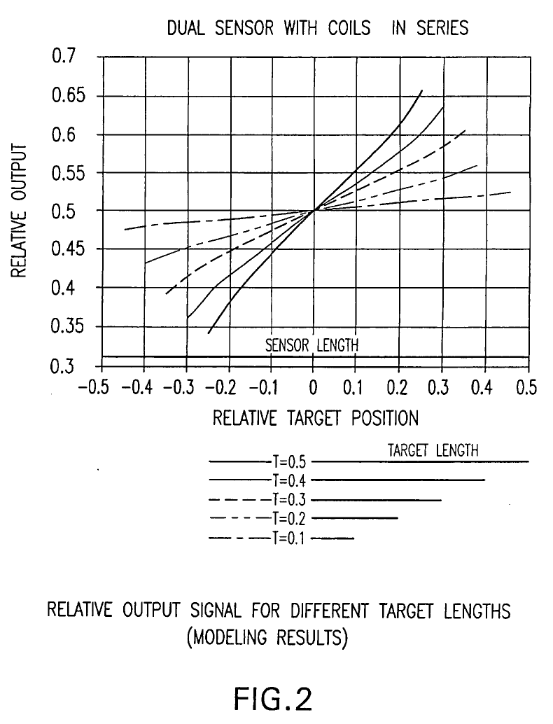

There is, however, some limitation for using a short target. The shorter the target relative to the sensor length, the lower the output signal, as illustrated in FIG. 2. Nevertheless, in many cases minimizing the sensor length is far more important than a decrease in output signal magnitude, provided the signal remains sufficiently robust.

### Simplicity in Designing Desired Output Characteristics

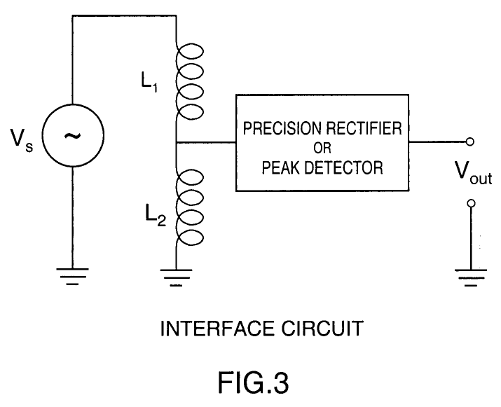

The advantage of being able to configure the sensor in a simple and reliable way for providing the desired output characteristics is self evident. The coil windings are in very close proximity to each other and uniformly distributed over a selected area resulting in, what could be called a constant “inductance per unit of area”, which is analogous to a capacitance per unit of area. There are several benefits to this approach:
To design a sensor having desired output characteristics one can simply substitute the size of coil areas for their respective inductance values in the voltage divider formula. The inductance of the coil portion under the target is reduced by a certain factor due to eddy currents. The “effective size” of the coil area under the target is reduced by the same factor.
Another benefit is maximization of the coil inductance, hence its impedance, which leads to a minimum load current. Minimum spacing between the coil turns is responsible for this benefit since it maximizes the total length of the coil forming conductor.
Only a very simple interface circuit is required as shown in FIG. 3. It comprises an AC voltage source supplying a constant voltage to coils L₁ and L₂ connected in series, which constitutes an inductive voltage divider. The amplitude of the AC output voltage at the center of this voltage divider correlates very accurately with the target position. The magnitude of the output voltage is then converted to a DC signal. In most cases, the standard range of the DC output voltage is from 0.5V to 4.5V.

### Insensitivity to Air Gap Variations

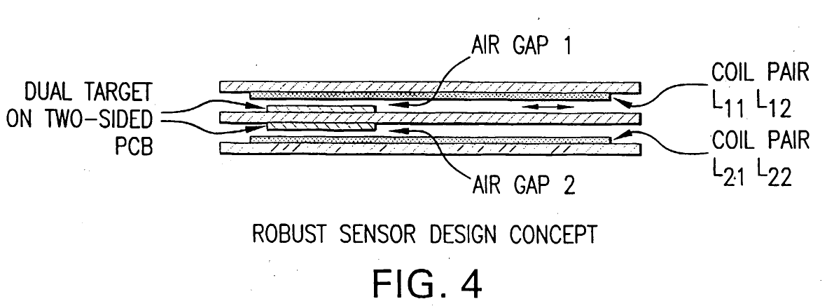

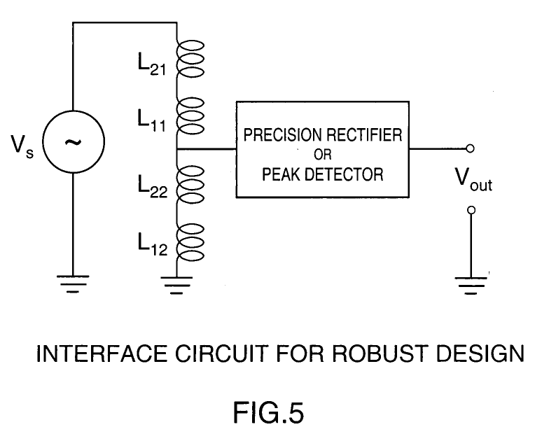

This is accomplished using an arrangement of two stationary coil pairs, once above the other, and a moving target in between as depicted in FIG. 4. The coil pairs are a mirror image of each other. Thus two different PCBs are required. Although the moving PCB carrying a dual target is constrained by design to permit movement only in the longitudinal direction, manufacturing tolerances and wear can lead to small deviations of air gaps, either fixed or variable. The design of FIG. 4 is self compensating in this respect because any change in one air gap is offset by the change in the other air gap. This compensation is transferred to the output signal by combining the corresponding coils of each pair, i.e., L₁₁ with L₂₁ and L₁₂ with L₂₂. Although, they can be combined in either a serial or a parallel way, serial connection of the coils is preferred since it offers the benefits of superior inherent target misalignment compensation and a smaller drive current. The corresponding interface circuit is shown in FIG. 5. In order to avoid using bipolar voltage supplies, sensor users, virtually without exception, require the sensor output signal to have a single polarity. This circuit meets this requirement without any additional means.

If the manufacturing tolerances are acceptable and hence, a self compensation is not required, the sensor of FIG. 4 can be configured as a differential sensor and double the output signal. For such an embodiment, the two coil pairs are connected into a bridge configuration. Now however, the output voltage not only has variable amplitude in relation to target position but also undergoes phase change at the midpoint of the sensor, which complicates the interface circuit. The signal phase needs to be converted into signal polarity and be combined with the value of the signal magnitude into one output signal. This will be a bipolar signal. In order to meet the single polarity requirement stated above, an additional DC offset needs to be incorporated into the sensor output signal.

### Short Range Sensor

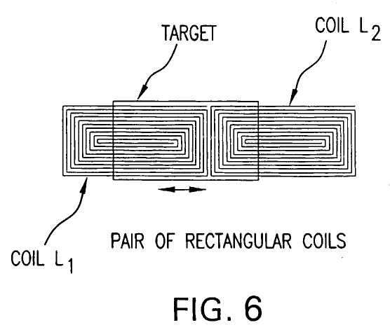

If the measuring range is short, or the fact of having a sensor twice as long as its range is not objectionable, then the pair of triangular coils in FIG. 1 can be replaced by a pair of rectangular coils shown in FIG. 6. Now the sensor has a fixed target length and range equal to one half of the sensor length. However, its output voltage is doubled. Also, the robust sensor design of FIG. 4 is implemented now with two PCBs having identical rectangular coil pairs. As with the triangular coils, a bridge arrangement is feasible, once again doubling the output voltage, however, with the penalty of a more complex interface circuit.

### Linearity

As displayed in FIG. 2, the results of modeling as well as those of subsequent testing show nonlinear output characteristic at each end of the measuring range. This often decreases the usable operating range of the sensor due to required degree of linearity. Magnetic end effects are responsible for the diminished influence of the sharp triangular ends of the coils. This non-linearity of the output signal is corrected by increasing the coil surface area of the triangular end sections with respect to the size of the large abutting section of the second coil.

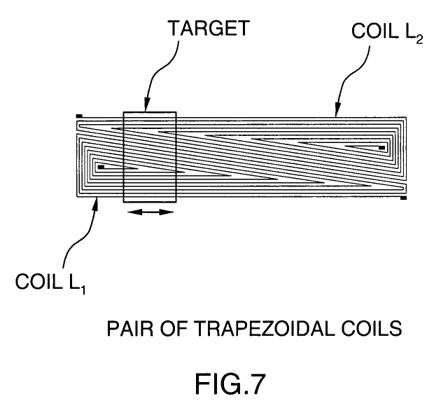

A very simple and effective way of obtaining end-to-end linear output is to replace the pair of triangular coils with a pair of trapezoidal coils as shown in FIG. 7.

While the invention has been described with reference to exemplary embodiments, it would be understood by those skilled in the art that various changes may be made in equivalence may be substituted for elements thereof without departing from the scope of the invention. In addition, many modifications may be made to adapt a particular situation or material to the teachings of the invention without the departing from the essential scope thereof. Therefore, it is intended that the invention not be limited to the particular embodiments disclosed and contemplated for carrying out this invention, but that the invention would include all embodiments falling within the scope of the appended claims. References noted above are hereby incorporated by reference.

1. A position sensor comprising:
a first printed circuit board;
a pair of stationary planar air-core coils, each formed in a substantially trapezoidal shape and side-by-side one another on the printed circuit board, such that the periphery of the combined pair of side-by-side coils defines a substantially rectangular shape, having coil windings relatively uniformly distributed over a predetermined area of the printed circuit board; and
a movable target formed by a sheet of copper on a second printed circuit board proximate to the first printed circuit board.

2. The position sensor according to claim 1, wherein the coil windings are constructed and arranged to effect substantially constant inductance per unit of area.

3. The position sensor according to claim 1, comprising a third printed circuit board comprising a pair of coils, wherein the first and third circuit boards are disposed one above the other separated by a gap and the target is constrained to move within the gap.

4. The position sensor according to claim 3, wherein the coil pairs are substantially mirror images of each other.

5. The position sensor according to claim 3, wherein the target comprises a two-sided printed circuit board with a copper pattern on each face.

6. (canceled)

7. A position sensor according to claim 3, wherein the sensor is constructed and arranged to be substantially insensitive to air gap variation.

8. (canceled)

9. The position sensor according to claim 3, wherein coils of each pair corresponding to a given direction of inductance change for a given direction of target movement are electrically combined.

10. A position sensor according to claim 9, wherein the combination of coil pairs are combined in series or in parallel.

11. The position sensor according to claim 3, wherein the coil pairs are electrically connected in a bridge configuration and coils corresponding to a given direction of inductance change for a given direction of target movement are disposed in non-adjacent legs of the bridge circuit.

12. A position sensing system comprising:
A first printed circuit board;
a pair of stationary planar air-core coils, each formed in a substantially trapezoidal shape and side-by-side one another on the printed circuit board, such that the periphery of the combined pair of side-by-side coils defines a substantially rectangular shape, having coil windings relatively uniformly distributed over a predetermined area of the printed circuit board;
a movable target formed by a sheet of copper, said target constrained to move along an axis separated from and substantially parallel to the plane of the circuit board, said target disposed such that a projection of said target onto said coils covers the combined width of said coils in a direction transverse to the axis of motion of said movable target, wherein said coils and said target cooperate to effect an increase in inductance of one coil and a decrease in inductance in the other coil in the coil pair when the target is moved in a direction along the axis of motion; said coil pair connected electrically in series, with a source of alternating current connected to supply current through the series combination of coils; and
a circuit comprising a precision rectifier or peak detector disposed to convert a signal derived from the interconnection point of the series connected coils into an output voltage.
